(19) United States
(12) Patent Application Publication
(10) Pub. No.: US 2018/0135990 A1
(43) Pub. Date: May 17, 2018

(54) METHODS AND DEVICES TO SELECT A TRAVEL MODE AND TRAVEL ROUTE MANAGEMENT SYSTEMS

(71) Applicant: Ford Global Technologies LLC, Dearborn, MI (US)

(72) Inventors: Yvonne Zhang, Nanjing (CN); Ryan Abraham McGee, Nanjing (CN); Sifei Wang, Nanjing (CN)

(21) Appl. No.: 15/809,775

(22) Filed: Nov. 10, 2017

(30) Foreign Application Priority Data
Nov. 14, 2016 (CN) 201611009765.7

(51) Int. Cl. G01C 21/34; G01C 21/36

(52) U.S. Cl. CPC G01C 21/3407; G01C 21/3691; G01C 21/3492

(57) ABSTRACT

A method implemented in a travel mode selection device is provided. The method comprises obtaining weather information, determine rating indices for a plurality of travel manners corresponding to the weather information, and recommending at least one travel mode based on the rating indices.

### RELATED APPLICATION

This application claims the benefit of Chinese Patent Application No.: CN 201611009765.7 filed on Nov. 14, 2016, the entire contents thereof being incorporated herein by reference.

### FIELD

This application relates methods and devices to select a travel mode and travel route management systems, in particular, relates to methods and devices to select a travel mode based on weather information and travel route management systems to suggest a route for the selected travel mode.

### BACKGROUND

Various traveling manners are available in daily commuting. The selection of the travel manners can be affected by the weather condition because different weather conditions have different impacts on the travel manners. For examples, a storm may cause traffic congestion at rush hours, make it difficult to find a taxi, and cause difficult for the commuters via the subway to get to their destination after the getting out of the subway station. In another example, windy weather decreases the comfortability of walking or bike riding. In yet another example, walking in a poor air quality condition is not good to health. Therefore, it can be difficult for people to travel or commute with certain manners at some weather conditions.

A software application “weather 4D” developed by the APP4NAV, for tablets and mart phones, provides navigation and routing associated with weather prediction for boating and outdoor recreation. However, this software application is directed to outdoor recreation on water and does not consider the impact of the weather on routine travel or commuting. There is a need for a method and a system to select a travel mode among various travel manners considering the weather conditions.

### SUMMARY

According to one aspect of the present disclosure, a method implemented in a travel mode selection device is provided. The method comprises obtaining weather information, determine rating indices for a plurality of travel manners corresponding to the weather information, and recommending at least one travel mode based on the rating indices.

In one embodiment, the travel mode includes one travel manner or a combination of at least two travel manners.

In another embodiment, the method further comprises setting a rating criterion for the rating indices. The rating indices are numbers and setting the rating criterion includes setting a rating index for a travel manner suitable for the weather information to have a number greater than a rating index for a travel manner unsuitable for the weather information.

In another embodiment, the method further comprises receiving a user preference, and setting a priority travel condition based on the user preference; and recommending at least one travel mode is further based on the priority travel condition.

In another embodiment, the priority travel condition includes a priority travel manner, a travel comfortability and arrival time.

In another embodiment, recommending at least one travel mode includes obtaining an initial position and a destination; determining the travel mode based on the initial position and the destination; and calculating a travel index for a suitable travel manner based on the rating indices to determine at least one travel mode.

In another embodiment, the weather information includes one of a temperature, an air quality index, a raining condition, a snowing condition, and/or a wind condition.

In another embodiment, the travel manner includes one of walking, riding a bike, riding an electric bike, riding a shared bike, taking a bus, taking a subway train, taking a ferry, taking a tax, and/or a driving a personal car.

In another embodiment, the method further comprises estimating arrival time to the destination based on the weather information, and recommending the at least one travel mode is further based on the estimated arrival time.

In another embodiment, the method further comprises communicating the recommended travel mode to a navigation device and receiving a suggested travel route.

In another embodiment, the method further obtaining traffic information, wherein recommending the at least one travel mode is further based on the traffic information, the weather condition and an estimated time to the destination.

According to another aspect of the present disclosure, a travel mode selection device comprises a first collection module configured to obtain weather information; a processing module configured to determine rating indices for a plurality of travel manners according to the weather information; and a selection module configured to recommend at least one travel mode according to the rating indices.

In one embodiment, the device further comprises a first setting module configured to set rating criteria for the rating indices. The rating criterion includes a numerical system and a rating index for a travel manner suitable for the weather information has a greater value greater than a rating index for a travel manner unsuitable for the weather information.

In another embodiment, the device further comprises a second collection module configured to obtain travel information, and the travel information includes an initial position, a destination position and/or departure time.

In another embodiment, the device further comprises a second setting module configured to receive information from the second collection module and set a priority travel condition, and recommending a travel method is further determined based on the priority travel condition.

According to yet another aspect, a travel route management system comprises a travel mode selection device configured to obtain weather information from a weather content provider; determine rating indices for a plurality of travel manners corresponding to the weather information and recommended at least one travel mode based on the rating indices; and a navigation device configured to communicate with the travel mode selection device to obtain the recommended travel mode and suggest a travel route based on the recommended travel mode.

In one embodiment, the navigation device is further configured to receive traffic condition from a traffic content provider.

In another embodiment, the weather information includes one of real time weather information and weather forecast, and the traffic condition includes at least one of real time traffic information and predicted traffic information.

In another embodiment, the navigation device is further configured to suggest a new travel route when one of the weather information and the traffic information changes.

In another embodiment, the navigation device is an individual navigation device or is integrated in an in-vehicle navigation system, a smart phone. The travel mode selection device is integrated in the in the in-vehicle navigation system or the smart phone

The methods and devices to of the present disclosure select a travel mode according to the weather condition. Thus, a travel mode can be planned based on the weather information to reduce the effects from the weather situation. Further, the method and the system to manage the travel route obtain traffic information to evaluate the impact of the weather on the routes, such that a user can avoid the routes of heavy traffic, traffic accidents, and bad road conditions.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

Example embodiments will be more clearly understood from the following brief description taken in conjunction with the accompanying drawings. The accompanying drawings represent non-limiting, example embodiments as described herein.

FIG. 1 is a block diagram of a travel mode selection device according to embodiment of the present disclosure.

FIG. 2 is a flow chart of a method to select a travel mode according to one embodiment of the present disclosure.

FIG. 3 is a flow chart of a method to perform a step of the method in FIG. 2.

FIG. 4 is an example chart of rating criteria for various travel manners at different weather conditions according to embodiments of the present disclosure.

FIG. 5 is an example chart of rating criteria and rating indices for various travel manners at different weather conditions, illustrating the generation of the rating indices.

FIG. 6 is a flow chart of a method to perform a step of the method in FIG. 2.

FIG. 7 is a flow chart of a method to perform a step of the method in FIG. 2

FIG. 8 is a schematic diagram of a travel route management system according to one embodiment of the present disclosure.

FIG. 9 is a flow chart of a method to suggest a travel route for a recommended travel mode as implemented in the travel route management system according to one embodiment of the present disclosure.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed various methods and devices to select a travel mode and travel route management systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods and devices to select a travel mode and travel route management systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

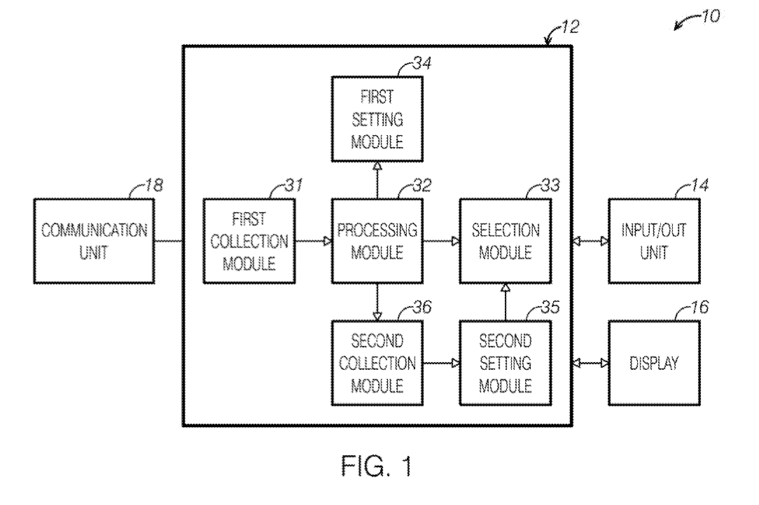

FIG. 1 is a block diagram of a travel mode selection device 10 according to one embodiment of the present disclosure. The travel mode selection device 10 or the device 10 may include a control unit 12, an input/output unit 14, a display 16 and a communication unit 18. In some embodiments, the travel mode selection device 10 may be a smart phone including the control unit 12 or a software application having functions of the control unit 12. The software application may be downloaded to the smart phone or may be accessed over a network. In some embodiments, the travel model selection device may a portable navigation device or an in-vehicle human machine interaction (HMI) device.

The control unit 12 may include a processing module 32, a first collection module 31, a first setting module 34, and a selection module 33. The first collection module 31 is configured to obtain weather information and transmit the weather information to the processing module 32. The first setting module 34 is configured to set rating criteria for the rating indices. The processing module 32 is configured to receive the weather information, determine rating indices for a plurality of travel manners corresponding to the weather conditions according to the weather information from the first collection module 31 and the rating criteria. The rating criteria may be preset and stored in the first setting module 34 or may be updated by a software application to select a travel mode based on the weather. The travel manners in this application refer to the manners that a person uses to go from a first location to a second location. For example, the travel manners include walking, riding a personal translation device such as a bike, an electric bike, an electric scooter or using a public transportation such as a bus, a subway or taking a taxi.

The selection module 33 is configured to determine at least one recommended travel mode based on the rating indices. The travel mode may include a single travel manner such as riding a bike or a combination of at least two travel manners such as riding a bike and using the public transportation. The travel mode can be selected based on the weather condition.

The control unit 12 may further include a second collection module 36 communicated with the processing module 32, and a second setting module 35 communicated with the selection module 33. The second collection module 36 is configured to obtain trip information including an initial position, a destination and/or departure time. The second setting module 35 is configured to receive the trip information from the second collection module 36 and set a priority travel condition. Thus, the selection module 33 may further determine the travel mode based on the priority travel condition.

Each module of the control unit 12 may include one of a processor and a memory to perform the functions. For example, the processing module 32, the selection module 33, and the first setting module 34 may include the processors having processing and programming functions and a memory. The rating criteria for the rating indices may be programmed or stored into the first setting module 34. The processors of processing module 32 and the selection module 33 may execute a routine to process the data received from the first collection module 31, the first setting module 34 and the second collection module 36 to determine the rating indices. It should be appreciated that the control unit 12 may be a single data processing system to incorporate the functions of the modules described above.

In some embodiments, the selection module 33 may have a display function to show the recommend traveling mode to the user. In some embodiments, the selection module 33 may communicate with other units to present the recommended travel mode. The recommended travel mode may be presented by an audio device or a display. For example, the display 16 is communicated with the selection module 33 to provide an output capable of displaying recommended travel mode, and/or suggested travel routes or other related information.

The second collection module 36 and the second setting module 35 may communicate with the input/output unit 14 for the user to input the trip information, and set a priority travel condition based on the user preference. For example, the input/output unit 14 may provide a connection for the user input through a keyboard, a mouse, a touch screen and/or some other suitable input device. The input/output unit 14 may provide a user-interface with controls to allow the user to define, for example, an initial position and a destination of a trip and into other information. The input/output unit 14 may also allow the user to enter his/her preferred travel condition. In another example, the input/output unit 14 may allow the user to enter a travel mode to a navigation device to obtain a suggested travel route. In yet another example, the input/output unit 14 may include an actuation button for the user to initiate the software application to select a travel mode.

The communication unit 18 may be one or more receivers and/or transmitters that allow the device 10 to connect to other devices, a network or a server. The communication unit 18 may employ a wireless communications link such as Wi_Fi, cellular communications, and/or satellite communications. In this way, the travel mode selection device 10 can access software application in a cloud, such as a software application for the travel mode selection and access a navigation application in the cloud. Further, the travel mode selection device may further obtain information from servers such as a weather content provider or a traffic content provide over a network.

An example routine executed in the travel mode selection device 10 includes setting a rating criterial of the rating indices for a plurality of traveling manners in the first setting module 34, obtaining an initial position and destination position from a user via the second module 36, and determining a plurality of traveling manners based on the initial position and destination position, setting a priority traveling condition via the second setting module 35, obtaining weather information from the first collection module 31, determining the rating indices for a plurality of travel manners corresponding to the weather information according to the weather information by the processing module 32, and determining at least one recommended travel mode based on the rating indices and the priority travel method by the selection module 33.

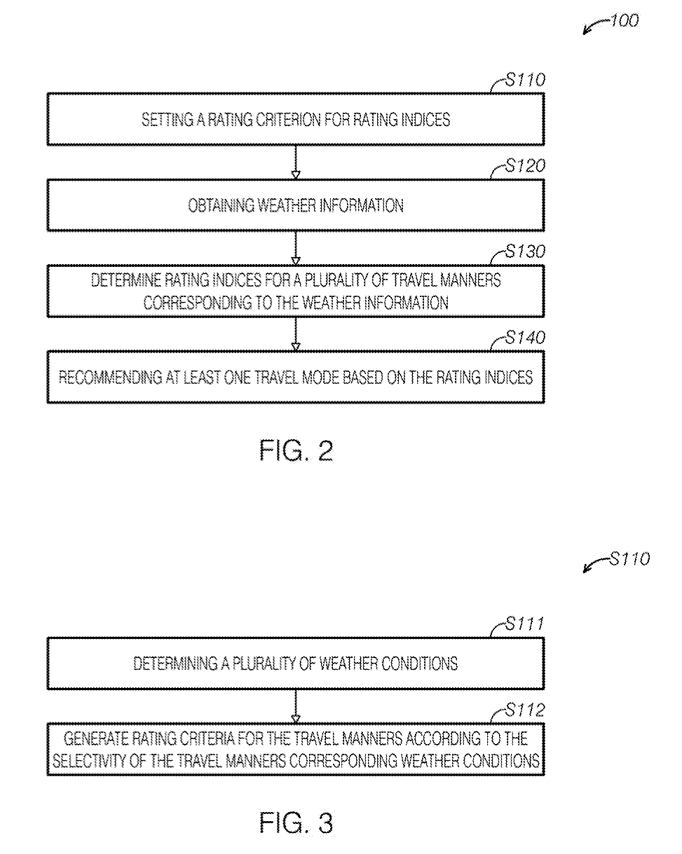

FIG. 2 is a flow chart of a method 100 to select a travel mode according to one embodiment of the present disclosure. The method 100 may be implemented in the travel mode selection device 10. The method 100 comprises setting a rating criterion for rating indices at S110; obtaining weather information at S120; determine rating indices for a plurality of travel manners corresponding to the weather information according to the obtained weather information at S130; and recommending at least one travel mode based on the rating indices. For the illustration purpose, this invention is described based on the travel on the land. It should be understood that the invention is applicable to other travel means such as traveling on the water or in air. The method 100 may include other, alternative, or additional elements; may omit one or more elements; and/or may follow a different sequence of elements from that listed. The travel referred to in this application may include any types of travels such as a long-distance trip, a local trip, or routine commutes between a work place and a home.

Continuing with FIG. 2, at S120, the method 100 includes obtaining weather information. For example, weather information includes weather conditions such as an ambient temperature, an air quality index, a raining condition, a snowing condition, and/or a wind condition. Further, the weather information may include information on the precipitation of rain and snow and an iced road. The weather condition may have an effect on the travel manners. For example, rain or snow may affect possibility or suitability of a travel manner by walking or biking. In another example, the temperature and windy conditions may affect the comfortability of a travel manner by walking or biking. In yet another example, an air quality may affect the comfortability of a travel manner such as walking or biking, and a high air quality index is not good to health.

Determining the rating indices for a plurality of travel manners corresponding to the weather information at S130 may include determining the rating indices for the plurality of travel manners at various weather conditions. Based on the rating indices, the method 100 can determine whether one or more travel manner can be recommended to a user. In one or more embodiments, the travel manners may include walking, riding a bike, an electric bike, an electric skyboard, a Segway, or an electric unicycle, or other traveling manners suitable for a short distance trip. The travel manners may further include taking a bus, a subway train, or a tax, and/or driving a personal car for the traveling manners suitable for a long-distance trip. In addition, the travel manners may further include traveling manners on water, such as taking a ferry or a boat, or traveling manners in air such as taking a helicopter or an airplane. Determining the recommended travel manners at S130 may include the travel manners used to travel from an initial position of the user to a destination.

FIG. 3 is a flow chart of a method to set rating criteria of the rating indices at S111 of the method 100. The rating criterion may be set based on the selectivity or suitability of the plurality of travel manners at different weather conditions. At step S111, the method 100 may determine weather conditions used to evaluate the selectivity of travel manners. At step S112, the method 100 may generate rating criteria for the travel manners according to the selectivity of the travel manners corresponding weather conditions. Although the rating criteria is set before obtaining the weather information as shown in FIG. 2, the rating criteria can be set at any other time as necessary, such as setting the rating criteria after obtaining weather information. Additionally or alternatively, the rating criteria may be set originally by user or a vendor and stored in the database for search or use the rating criteria based on a specific need.

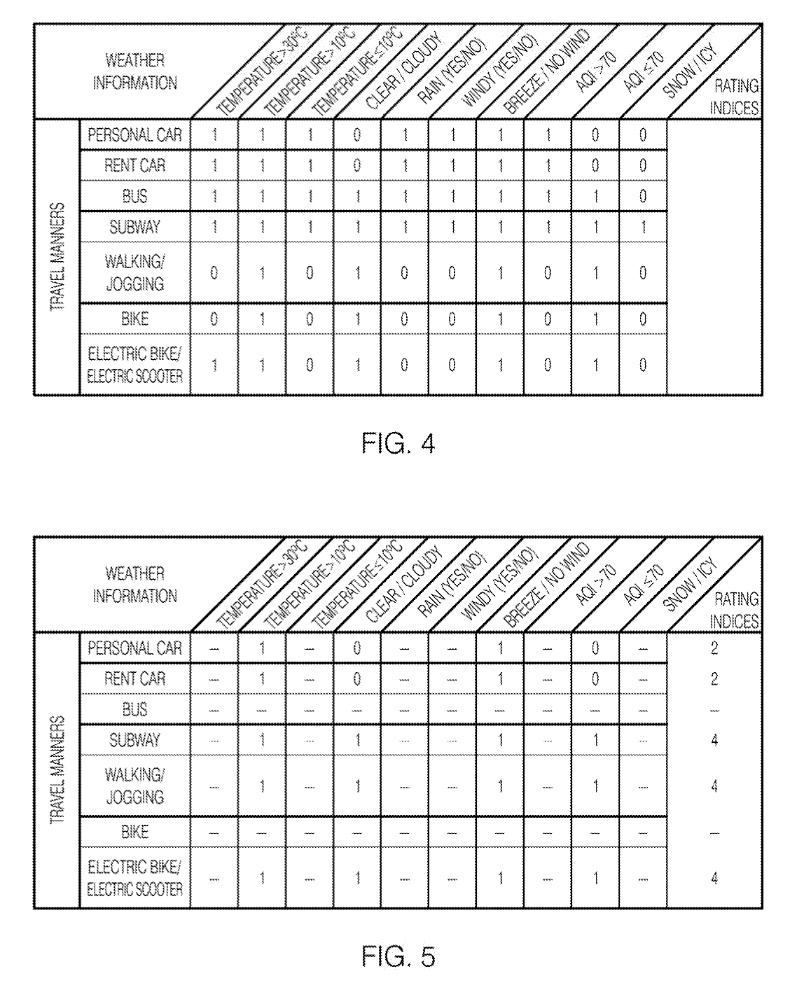

Referring to FIG. 4, an example chart of rating criteria for various travel manners at different weather conditions is shown. As shown in FIG. 4, weather conditions may be categorized as a plurality weather conditions from various aspects such as temperature, AQI, wind level, which include the plurality of weather information obtained at step S120. In some embodiments, a weather condition can be categorized to include categories of temperature higher than 30° C., temperature between 10° C. to 30° C., and temperature lower than 10° C. The rating criteria are further determined based on different weather conditions and may be a numerical system. For example, the rating criterion for a traveling manner suitable for a weather condition is set as 1. while a rating criterion for a weather condition unsuitable for the travel manner is set as 0. For example, when temperature is higher than 30° C., the travel manners such as driving a personal car, taking a taxi, taking a bus, taking a subway train, riding an electric bike and an electric scooter may be suitable or have a selectivity. Thus, the rating criteria for these travel manners are rated as 1. When temperature is higher than 30° C., it is unsuitable for traveling manners such as walking, jogging, biking. That is, these travel manners do not have selectivity. Thus, the rating criteria for these traveling manners are rated as 0. Based on the selectivity of the travel manners, the rating criteria of the travel manners may be set as a numerical system. For example, the numbers in a range of 1, 2, 3, . . . 100 are assigned. In addition, the weather conditions may be categorized based on the need. For example, the weather condition may further include information on the precipitation. In the weather condition with higher precipitation, the selectivity of a travel manner by driving a car is a higher than that of a travel manner by walking.

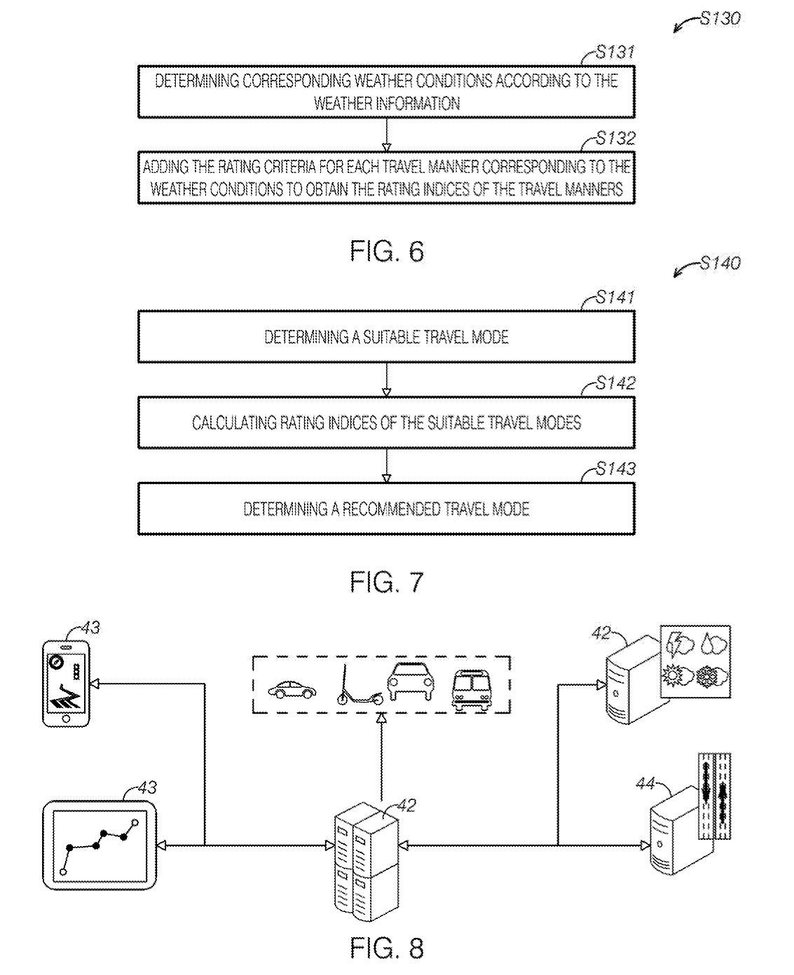

Referring to FIG. 6, at step S130, determining rating indices of the traveling manners corresponding to the weather information at step S130 may include determining corresponding weather conditions according to the weather information at S131. FIG. 5 schematically illustrates one unlimited example to determine rating indices of the traveling manner according to the rating criteria shown in FIG. 4. The rating criteria of the traveling manners corresponding to the weather conditions are added to obtain a rating index for the traveling manner corresponding to the weather information. Referring to FIGS. 5 and 6, at step S131, the weather condition to evaluate the traveling manner can be obtained based on the weather information. In the example shown in FIG. 5, the weather condition corresponding to the obtained weather information includes temperature between 10° C. to 30° C., clear or cloudy, windy or clam, AQI less than 70. At step S132, the method 100 includes s141. For example, in the embodiment as shown in FIG. 5, under this weather condition, the rating indices of traveling manners by driving a personal car and taking a taxi are 2, and the rating index of the travel manners by taking a subway train, walking/jogging, riding an electric bike and an electric scooter is 4.

Returning to FIG. 2, the method 100 includes recommending at least one travel mode based on the rating indices at S130. Referring to FIG. 7, a flow chart of a method to determine a recommended travel mode is shown. At step S141, the method 100 determines suitable travel modes. For example, the method 100 may include obtaining information on initial position, a destination, and/or departure time. The initial position may be defaulted as a current position of the user. Thus, a plurality of travel mode from the initial position to the destination may be determined based the user's initial position and the destination. Any one of these travel modes may include one or more travel manners.

At step S142, the method 100 may calculate travel indices of the suitable travel modes according to the rating indices for travel manners determined in step S130. According to one embodiment, a suitable travel mode may only include one single travel manner. For example, the travel mode may only include walking when an initial position is near a destination. Further, the travel index for this travel manner can be calculated based on the rating index of this travel manner. For example, the travel index for the travel mode of a single travel manner can be defined as the rating index for the single travel manner.

Alternatively, a travel mode may be a combination of at two travel manners. For example, when an initial position is far away from the destination, a travel mode may include at least two travel manners, such as a combination of walking, taking subway or taking a bus, or of a combination of driving a personal car and riding an electric scooter. Further, the rating indices for the plurality of travel manners of the travel mode may be weighted and summed to obtain a travel index for the traveling modes. In this way, the weights for multiple travel manner may be distributed based on various factors, such as a travel distance or travel time, or the weight may be increased or decreased according to the user preferences which is input by the user.

Next, at step S143, the method 100 may include determining a recommended travel mode. For example, the method 100 may sort the travel modes based on their travel indices, and recommend one or more travel modes with high travel indices to the user via an output unit such as an audio, a display device, or a human machine interaction.

Alternatively, the method 100 may set a priority travel condition based on user preferences. Priority travel conditions may include a user preferred travel manner, travel comfortability, and arriving time. The priority travel condition may further include a cost of the travel manner, a recharge mileage of an electric vehicle (e.g., an electric bike, an electric scooter, a Segway and an electric unicycle). At step S143, the method 100 may further determine a recommended travel manner based on the priority condition. The recommended travel mode is customized and improve the user experience when considering the priority condition. For example, if the user preferred travel manners do not include taking a bus and riding a bicycle, the rating indices for these two travel manners are not calculated.

In addition, when an initial position and destination are far away, and travel time is long, a plurality of sub-destinations may be set between the initial position and the destination. The arriving time to each sub-destination may be estimated and weather information at a sub-destination corresponding to the sub-arrival time are obtained. The rating indices for the plurality of travel manners corresponding to the forecasted weather information are determined based on the weather information, and at least one recommended travel mode is determined and suggested to the user.

Referring to FIG. 8, a schematic diagram of a travel route management system 40 is shown. The system 40 includes a travel mode selection device 41, and a navigation device 43 communicating with the selection device 41. It should be understood that communication between the devices can be achieved in various forms. For example, the devices may include a communication module to communicate via wire or wireless.

The travel mode selection device 41 is configured to obtain weather information, determines rating indices of a plurality of travel manners corresponding to the weather information, and determines at least one recommended travel mode based on the rating indices. The travel mode selection device 41 may include modules described in FIG. 1 and have the same or similar software and hardware or additional components. The travel mode selection device 41 may obtain the weather information from a weather content provider 42 over a network. The travel mode selection device 41 may be a software application or a control unit in a computing device. For example, the travel mode selection device 41 may be integrated or downloaded in a smart phone, a personal computer, a tablet, an in-vehicle device having human machine interface, or a navigation device.

The navigation device 43 is configured to obtain recommended travel mode and suggest a travel route based on the recommended travel mode. The navigation device 43 may suggest recommended travel mode to the user via an audio device, a visual display, or other human machine interaction devices. According to one or more embodiments, the navigation device 43 may be included in an in-vehicle navigation system, a navigation application in a smart phone, or a navigation application in a cloud. The in-vehicle navigation system is suitable for a vehicle owner, the smart phone may be suitable for many users, and the navigation application via a cloud may be suitable for the users having access to the network. The travel selection device 41 and the navigation device 43 may be integrated in one device such as a smart phone or the in-vehicle HMI device or may be installed in different devices. In some embodiments, the navigation device may be integrated in a mobile terminal such as a smart phone or a tablet and the travel mode selection device 43 may be integrated in the smart phone or the tablet. Further, the travel mode selection device 43 may be an application located at a server in the cloud. Further, the navigation device 43 may include a display and input functions to displays the travel route to the user and allows the user to input trip information such as an initial position, a destination, and departure time, and priority travel condition based on the user preference.

According to one embodiment of the present disclosure, the travel route management system 40 may further includes a traffic content provider 44 communicated with the navigation device 43 to provide traffic conditions to the navigation system 43. Additionally or alternatively, the navigation device 43 may obtain traffic information from public traffic information system. The traffic information includes at least one of real time traffic condition and forecast traffic condition, and may further include information on traffic flow, traffic accidents, and/or traffic condition information. The travel route management system 40 may further include a weather content provider 42 communicated with the travel mode selection device 41 to provide the weather information. The weather information includes real time weather information, and forecast weather information. The travel route management system obtains the traffic information and estimates the impact of the weather to the traffic condition to help the user to avoid routes having heavy traffic, traffic accidents, and poor road conditions. As the recommended travel route is based on the predicted traffic and the weather information, the suggested travel route can be more appropriate.

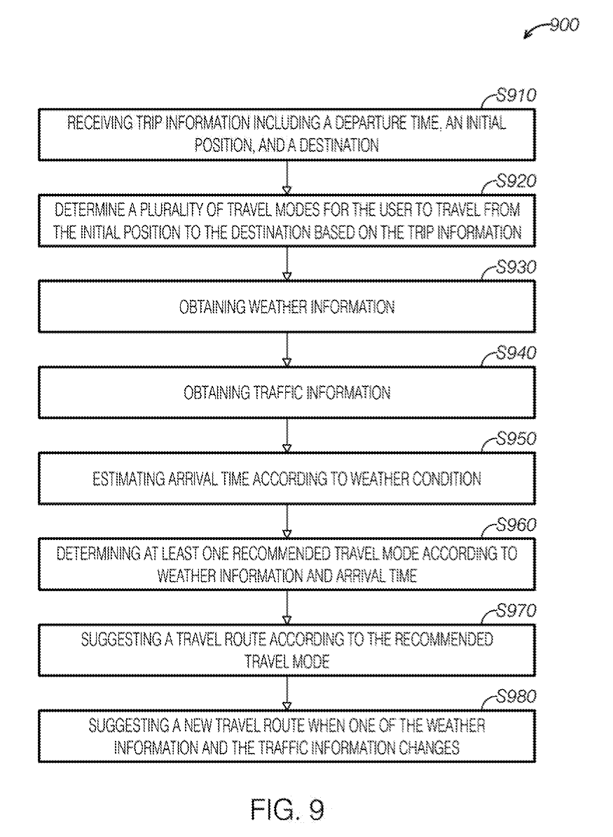

FIG. 9 is a flow chart of a method 900 to suggest a travel route which may be implemented in the travel route management system 40 in FIG. 8. In some embodiments, the travel route management system includes a travel mode selection device, a navigation device/application. A user can start the method b900 y turning on the application and entering trip information such as an initial position and a destination. At step S910, the method 900 may include receiving trip information including a departure time, an initial position, and a destination. In some embodiments, the current position of the user is defaulted as an initial position. In some embodiment, the destination may include one or more than two positions.

At step S920, the method 900 may determine a plurality of travel modes for the user to travel from the initial position to the destination based on the trip information. The plurality of travel modes may include one travel manner or a combinations of travel manners. As an unlimited embodiment, one travel mode may include walking to a first subway station closest to the initial position, taking a subway train to a second subway train station closest to the destination, then walking to the destination. In another example, another travel mode may include driving a car from the initial position to a parking lot closest to the destination, then riding an electric scooter to the destination.

At step S930, the method 900 includes obtaining weather information between the initial position and destination position. When the destination is in far away and travelling time is long, it may be necessary to obtain a weather forecast at the time of arriving in the destination. The weather information will be used to determine rating indices of travel manners later.

At step S940, the method 900 includes obtaining traffic information from the traffic content provider specific for the traffic route management system 40. Alternatively, the method 900 may also obtain traffic information from the public traffic information system. The traffic information can be used to suggest travel mode later.

At step S950, the method 900 may include estimating the impact of the weather on the traffic condition according to the weather information, and estimate the arrival time via the plurality of travel modes determined in the step S920.

At step S960, the method 900 may further includes determining travel indices of the plurality of travel manners and the travel indices of the travel modes which are combination of the travel manners based on the weather information. Based on the travel indices and arrival time estimated at step S950, the method 900 determines at least one recommended travel mode and transmits the recommended travel mode. In some embodiments, the recommended travel mode may be sent to the navigation device 43. In some embodiments, the recommended travel mode may be communicated to an input/out unit or a display of the travel mode selection device 41 to present to the user.

At step S970, the method 900 may suggest a travel route based on recommended travel mode and outputs the suggested travel route to the user. In some embodiments, the method 900 may output the suggested travel route to the navigation device 43 or a terminal communicated with the navigation device 43 or travel mode selection device 41. In this way, the user can avoid the routes with heavy traffic, traffic accidents, or poor traffic condition so that he or she can arrive in the destination via a travel mode having a shorter travel time.

According to one embodiment, at step S980, the method 900 further includes suggesting a new travel route when one of the current weather information/condition and traffic information/condition is changed. In one example, the travel mode selection device 41 may obtain current weather information from the weather content provider 42, and update the recommended travel modes based on the weather information and send to the navigation device 43 when the method 900 judges that weather will change and will be different at the current position and the destination. The navigation device 43 suggests new travel routes based on the newly recommended travel modes. Especially, when a weather change is predicated, a new travel route can be suggested to avoid the impact of the weather conditions.

In addition, when there is a long distance between an initial position and a destination position and thus a long traveling time, a plurality of sub-destination positions between the initial position and the destination position may be set. The method 900 may estimate the time to each sub-destination position, obtain the weather information at a sub-destination position corresponding to the sub-arrival time, estimate an effect to traffic condition on the corresponding road according to the forecast weather, and determine the arrival time via each travel manner or the combinations of the travel manners. At step S960, the method recommends at least one travel mode based on the weather information and arrival time via the selection device 41. Further at step S970, the method 900 suggests a travel route for the recommended travel mode via the navigation device 43

The systems and methods of the present disclosure recommend a travel mode for commuting based on weather information such that the adverse impact to a trip by weather conditions can be reduced. The systems and methods further set a priority travel condition based on the user preference, and thus the recommended travel mode is customized for the user. The systems and methods further obtain traffic information from a traffic content provider, and estimates an impact of the weather on the road conditions. In this way, the user can avoid roads with heavy traffic, traffic accidents, and poor road conditions.

The invention provides a method and a device to select a ravel mode, and a travel route management system. It should be understood that a flow chart or any routine or method described in the application may represent one or more logics or modules and segments with executable instructions. Various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. The present invention may be realized via hardware, software, or firmware or their combination. Various steps or methods may be stored in a memory and executed by appropriate system with executable software and hardware. For example, the hardware may be implemented in discrete logic circuits having logic gate to process data signal to logic function, a specific integrated circuit having appropriate logic gate combination, programmable gate array (PGA), field-programmable gate array (FPGA), or their combinations.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A method, implemented in a travel mode selection device, the method comprising:
obtaining weather information;
determine rating indices for a plurality of travel manners corresponding to the weather information; and
recommending at least one travel mode based on the rating indices.

2. The method of claim 1, wherein the travel mode includes one travel manner or a combination of at least two travel manners.

3. The method of claim 1, further comprising:
setting a rating criterion for the rating indices; wherein the rating indices are numbers and wherein setting the rating criterion includes setting a rating index for a travel manner suitable for the weather information to have a number greater than a rating index for a travel manner unsuitable for the weather information.

4. The method of claim 3, further comprising receiving a user preference, and setting a priority travel condition based on the user preference; and wherein recommending at least one travel mode is further based on the priority travel condition.

5. The method of claim 4, wherein the priority travel condition includes a preferred travel manner, a travel comfortability and arrival time.

6. The method of claim 4, wherein recommending at least one travel mode includes obtaining an initial position and a destination; determining the travel mode based on the initial position and the destination; and calculating a travel index for a suitable travel manner based on the rating indices to determine at least one travel mode.

7. The method of claim 1, wherein the weather information includes a temperature, an air quality index, a raining condition, a snowing condition, and/or a wind condition.

8. The method of claim 1, wherein the travel manner includes one of walking, riding a bike, riding an electric bike, riding a shared bike, taking a bus, taking a subway train, taking a ferry, taking a tax, and/or a driving a personal car.

9. The method of claim 6, further comprising estimating arrival time to the destination based on the weather information, wherein recommending the at least one travel mode is further based on the estimated arrival time.

10. The method of claim 6, further comprising transmitting the recommended travel mode to a navigation device and receiving a suggested travel route from the navigation device.

11. The method of claim 10, further comprising obtaining traffic information, wherein recommending the at least one travel mode is based on the traffic information, the weather condition and an estimated time to the destination.

12. A travel mode selection device, comprising:
a first collection module configured to obtain weather information;
a processing module configured to determine rating indices for a plurality of travel manners according to the weather information; and
a selection module configured to recommend at least one travel mode according to the rating indices.

13. The travel mode selection device of claim 12, further comprising a first setting module configured to set rating criteria for the rating indices; wherein the rating criterion includes a numerical system, and wherein a rating index for a travel manner suitable for the weather information has a greater value greater than a rating index for a travel manner unsuitable for the weather information.

14. The travel mode selection device of claim 12, further comprising a second collection module configured to obtain travel information, wherein the travel information includes an initial position, a destination position and/or departure time.

15. The travel mode selection device of claim 12, further comprising a second setting module configured to receive information from the second collection module and set a priority travel condition, wherein recommending a travel method is further determined based on the priority travel condition.

16. A travel route management system, comprising:
a travel mode selection device configured to obtain weather information from a weather content provider; determine rating indices for a plurality of travel manners corresponding to the weather information and recommend at least one travel mode based on the rating indices; and
a navigation device configured to communicate with the travel mode selection device to obtain the recommended travel mode and suggest a travel route based on the recommended travel mode.

17. The travel route management system of claim 16, wherein the navigation device is further configured to receive traffic condition from a traffic content provider.

18. The travel route management system of claim 17, wherein the weather information includes one of real time weather information and weather forecast, and the traffic condition includes at least one of real time traffic information and predicted traffic information.

19. The travel route management system of claim 14, wherein the navigation device is further configured to suggest a new travel route when one of the weather information and the traffic information changes.

20. The travel route management system of claim 16, wherein the navigation device is an individual navigation device or the navigation device is integrated in an in-vehicle navigation system, or a smart phone, and wherein the travel mode selection device is integrated in the in-vehicle navigation system or the smart phone.
